(19) United States
(12) Patent Application Publication
(10) Pub. No.: US 2012/0183686 A1
(43) Pub. Date: Jul. 19, 2012

(54) REACTOR SYSTEM AND METHOD OF POLYCRYSTALLINE SILICON PRODUCTION THEREWITH

(75) Inventor: Daniel Ohs, Moses Lake, WA (US)

(73) Assignee: REC Silicon Inc.

(21) Appl. No.: 13/350,570

(22) Filed: Jan. 13, 2012

Related U.S. Application Data
(60) Provisional application No. 61/434,310, filed on Jan. 19, 2011.

(51) Int. Cl. B05D 1/22; F17D 1/00; B01J 8/24

(52) U.S. Cl. 427/213; 422/145; 137/1

(57) ABSTRACT

Embodiments of a method for reducing or mitigating metal contamination of polycrystalline silicon are disclosed. In particular the disclosure relates to a method of mitigating metal contamination of granulate polycrystalline silicon, during its manufacture in a fluidized bed reactor unit, resulting from contact with a metal surface of components of the supporting transportation and auxiliary infrastructure by use of a protective coating comprising silicon or a silicon-containing material.

### CROSS REFERENCE TO RELATED APPLICATION

This claims the benefit of U.S. Provisional Application No. 61/434,310, filed Jan. 19, 2011, which is incorporated herein in its entirety by reference.

### FIELD

The present disclosure concerns reduction or mitigation of metal contamination of polycrystalline silicon. In particular, the disclosure relates to mitigation of metal contamination of particulate or granulate polycrystalline silicon, during its manufacture in a fluidized bed reactor unit, from a metal surface of components of the supporting transportation and auxiliary infrastructure.

### BACKGROUND

Silicon of ultra-high purity is used extensively for applications in the electronic industry and the photovoltaic industry. The purity demanded by industry for these applications is extremely high, and frequently materials with only trace amounts of contamination measured at the part per billion levels are deemed acceptable. By rigorous control of the purity of the reactants used to manufacture polycrystalline silicon, it is possible to produce such high purity polycrystalline silicon but then extreme care must be taken in any handling, packaging and/or transportation operations to avoid post contamination. At any time the polycrystalline silicon is in contact with a surface, there is a risk of contamination of the polycrystalline silicon with that surface material. If the extent of contamination exceeds certain industrial stipulations, then the ability to sell the material into these end applications may be restricted or even denied. In this respect, minimizing contact metal contamination is a primary concern if performance criteria in the semiconductor industries are to be attained.

A process for manufacturing polycrystalline silicon that is now gaining in commercial acceptance involves the use of a fluidized bed reactor (FBR) to manufacture granulate polycrystalline silicon by the pyrolysis of a silicon-containing gas in the presence of seed particles. During the use of a fluidized bed reactor system to manufacture the granulate polycrystalline silicon, there are a number of transportation steps where granulate polycrystalline silicon, or seed particles, may be moved from the bed of the fluidized reactor to a point where it is external to the reactor chamber, and particularly in the case of granulate polycrystalline silicon, when it is desired to harvest the polycrystalline silicon. At all stages of transportation of granulate polycrystalline silicon, there is a risk of contamination by physical contact with the surfaces of the equipment with which it touches including notably the metal surfaces of the supporting infrastructure of the FBR system, external to the fluidized bed, thereby leading to metal contamination. Exemplary of supporting infrastructure are the pipelines and transfer conduits through which granulate polycrystalline silicon must pass. Accordingly there is a need to mitigate the opportunity of metal contamination from such auxiliary structure and equipment.

### SUMMARY

According to one aspect, this disclosure concerns a method of reducing or eliminating contamination of particulate silicon from contact of a metal surface, such as the inner surface of a metal conduit, wherein said metal surface is at least partially coated with a protective coating comprising silicon or a silicon-containing material.

According to a further aspect, this disclosure relates to a modified fluidized bed reactor unit for production of granulate polycrystalline silicon wherein the modification comprises use of metal pipes, external to the reactor chamber, and wherein said metal pipes have their inner surfaces at least partially coated with a protective coating comprising a silicon or silicon-containing material.

According to a yet further aspect, this disclosure relates to a process for the production of granulate polycrystalline silicon, which comprises use of a fluidized bed reactor to effect pyrolysis of a silicon-containing gas and deposit a polycrystalline silicon layer on a seed particle wherein the transportation of the seed particle prior to entry, or after exit from the fluidized bed reactor, is via metal feed or discharge conduit having an inner surface wall at least partially coated with a protective coating comprising silicon or a silicon-containing material.

### BRIEF DESCRIPTION OF THE DRAWING

FIG. 1 is a schematic cross-sectional elevational view of a fluidized bed reactor.

### DETAILED DESCRIPTION

Unless otherwise indicated, all numbers expressing quantities of components, percentages, thicknesses, and so forth, as used in the specification or claims are to be understood as being modified by the term “about.” Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximates unless the word “about” is recited.

The expressions “at least partial protective layer” and “coated at least partially” in this context imply that the protective layer need not cover the metal conduit surface completely. Discontinuities in the protective layer may be due to, e.g., cracking caused by stretching or bending of the substrate material; to grain boundaries particularly in a crystalline material; to insufficient cleaning prior to the coating process; impurities or particles on the substrate surface; or to physical damage. Additionally, surface areas that are recognized as being non- or low-contact areas for polycrystalline silicon (e.g., seed particles and granulate polysilicon) may not be coated. Sections of the surface may also be left uncoated, e.g., for technical reasons relating to the joining of parts.

Contact metal contamination is reduced considerably by using at least a partial protective coating as disclosed herein, even if the protective coating includes discontinuities as described above. In some embodiments, at least 50% or at least 75% of the metal surface is coated by a protective coating. In another embodiment, the surface is completely covered by a protective coating. “Completely” means that the protective coating is essentially free from defects such as discontinuities in the coating as described above.

A protective coating may include several layers with different functionalities. Typical functional layers include, for example, primer layers, adhesion layers, and barrier layers. In some embodiments, the protective coating, or the outermost layer if the coating comprises multiple layers, that will be in contact with the particulate polycrystalline silicon comprises elemental silicon or a silicon-containing material with high silicon content. By “high content” it is understood that the silicon content of such silicon-containing material will be at least 25 wt %, such as at least 35 wt % or at least 45 weight percent. By “protective layer coating” it is understood that the coating has an overall average thickness of from at least 0.1 mm, such as at least 0.3 mm or at least 0.5 mm, up to a thickness of 10 mm, such as up to 7 mm or up to 4 mm. Exemplary silicon-containing materials suitable for use as a protective coating include silica glass, quartz, silicon carbide, and silicon nitride. In some embodiments, the protective coating is elemental silicon or silica glass. In one arrangement, the protective coating is silica glass present at a thickness of from 0.5 to 4 millimeters.

The composition of silica glass varies with respect to trace metals, depending on source and the formulation used for its manufacture, and the desired physical properties to be exhibited by the silica glass. With respect to mitigating metal contamination of polycrystalline silicon, it is desirable that certain elements if present in the silica glass do not exceed given amounts. Elements of note that may be present due to the formulation used to prepare silica glass include boron, phosphorus, iron, nickel, chromium, and/or cobalt. Silica glass particularly suitable for embodiments of the disclosed protective coating is that where the individual amount of any of these elements does not exceed 1.5 wt % based on total weight of the silica glass. In some embodiments, the individual amount of any of these elements does not exceed 1.2 wt % or does not exceed 0.8 wt % based on total weight of the silica glass.

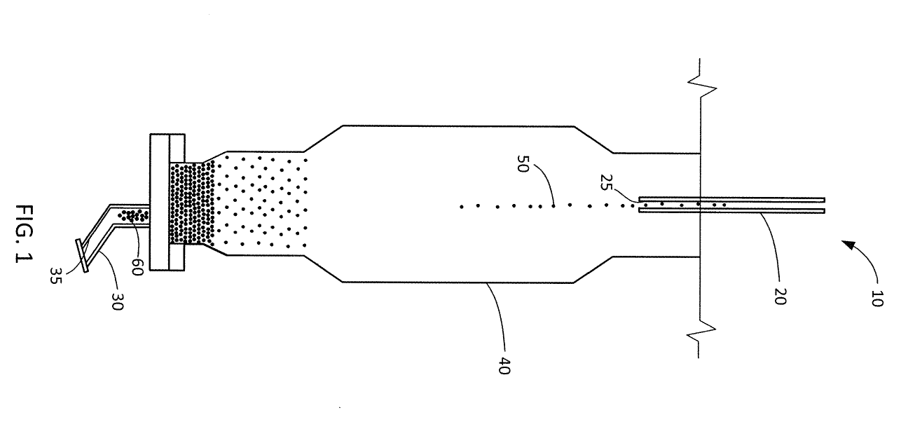

In one aspect as shown in FIG. 1, a modified fluidized bed reactor unit 10 is utilized for production of particulate or granulate polycrystalline silicon wherein the modification comprises use of metal conduit, or pipes 20, 30, external to the reactor chamber 40, wherein the metal pipes 20, 30 have their inner surface 25, 35 at least partially coated with a protective coating comprising a silicon or silicon-containing material as described hereinabove. Such metal pipes include, for example, a feed pipeline 20 or discharge pipeline 30 associated respectively with the feed of particulate polysilicon seed 50 to the reactor chamber 40, or discharge and harvesting of granulate polysilicon 60 from the reactor chamber 40. The protective layer functions to prevent direct contact of the polycrystalline silicon particle 50, 60 with the metal pipe's inner surface 25, 35 and thereby reduces or eliminates metal contamination of the polycrystalline silicon particle.

In certain embodiments, the modification is the use of feed and/or discharge pipelines wherein the protective coating is present in an amount (thickness) of from 0.5 mm to 4.0 mm; wherein the protective coating is a silica glass; and wherein the individual amount of any of the following elements in the silica glass including boron, phosphorus, iron, nickel, chromium and cobalt does not exceed 1.5 wt %, 1.2 wt %, or 0.8 weight percent based on total weight of the silica glass.

Procedures for manufacturing silica glass-lined metal conduits, or pipes, are reported in the literature and exemplified by publications such as U.S. Pat. No. 3,129,727 and Japanese Patent Application JP2001131777. Silica glass-lined metal pipes suitable for the present invention are commercially available from suppliers such as Estrella (Lansdale, Pa.), which provides carbon steel pipes lined with a silica glass identified as ESTRELLA 2000®.

The manufacture of a particulate polycrystalline silicon by a chemical vapor deposition method involving pyrolysis of a silicon-containing substance such as for example silane, disilane or halosilanes such as trichlorosilane or tetrachlorosilane in a fluidized bed reactor is well known to a person skilled in the art and exemplified by many publications including those listed below and incorporated by reference.

| Title | Publication Number |
|---|---|
| Fluidized Bed Reactor for Production of High Purity | US2010/0215562 |
| Silicon | |
| Method and Apparatus for Preparation of Granular | US2010/0068116 |
| Polysilicon | |
| High-Pressure Fluidized Bed Reactor for Preparing | US2010/0047136 |
| Granular Polycrystalline Silicon | |
| Method for Continual Preparation of Polycrystalline | US2010/0044342 |
| Silicon using a Fluidized Bed Reactor | |
| Fluidized Bed Reactor Systems and Methods for Reducing | US2009/0324479 |
| The Deposition Of Silicon On Reactor Walls | |
| Process for the Continuous Production of Polycrystalline | US2008/0299291 |
| High-Purity Silicon Granules | |
| Method for Preparing Granular Polycrystalline Silicon | US2009/0004090 |
| Using Fluidized Bed Reactor | |
| Method and Device for Producing Granulated | US2008/0241046 |
| Polycrystalline Silicon in a Fluidized Bed Reactor | |
| Silicon production with a Fluidized Bed Reactor integrated | US2008/0056979 |
| into a Siemens-Type Process | |
| Silicon Spout-Fluidized Bed | US2008/0220166 |
| Method and Apparatus for Preparing Polysilicon Granules | US2002/0102850 |
| Method and Apparatus for Preparing Polysilicon Granules | US2002/0086530 |
| Machine for Production of Granular Silicon | US2002/0081250 |
| Radiation-Heated Fluidized-Bed Reactor | U.S. Pat. No. 7,029,632 |
| Silicon Deposition Reactor Apparatus | U.S. Pat. No. 5,810,934 |
| Method for Silicon Deposition | U.S. Pat. No. 5,798,137 |
| Fluidized Bed for Production of Polycrystalline Silicon | U.S. Pat. No. 5,139,762 |
| Manufacturing High Purity/Low Chlorine Content Silicon | U.S. Pat. No. 5,077,028 |
| by Feeding Chlorosilane into a Fluidized Bed of Silicon | |
| Particles | |
| Fluid Bed Process for Producing Polysilicon | U.S. Pat. No. 4,883,687 |
| Fluidized Bed Process | U.S. Pat. No. 4,868,013 |
| Polysilicon Produced by a Fluid Bed Process | U.S. Pat. No. 4,820,587 |
| Reactor And Process for the Preparation of Silicon | US2008/0159942 |
| Ascending Differential Silicon Harvesting Means and | U.S. Pat. No. 4,416,913 |
| Method | |
| Fluidized Bed Silicon Deposition from Silane | U.S. Pat. No. 4,314,525 |
| Production of Silicon | U.S. Pat. No. 3,012,861 |
| Silicon Production | U.S. Pat. No. 3,012,862 |

The expression “particulate” or “granulate” refers to polycrystalline silicon that can be seed material brought into the reactor through a feed line or product exiting the reactor via the discharge pipeline and encompasses material having an average size in its largest dimension of from about 0.01 micron to as large as 15 millimeters. More typically, the majority of the particulate polycrystalline silicon in passage through the feed or discharge pipelines will have an average particle size of from about 0.1 to about 5 millimeters.

It is observed that such glass-lined pipes are able to satisfactorily mitigate metal contamination of the granulate polysilicon during transportation in the FBR manufacturing operations and are surprisingly robust with minimal failure. Abrasive failure or fractures of the glass lining through the transportation of granulate polysilicon at various conveyance speeds is surprisingly low or absent. Silica glass contamination of the polysilicon is also observed to be minimal and not distracting from the overall quality of the polysilicon.

Although the subject invention has been described with respect to preferred embodiments, those skilled in the art will readily appreciate that changes or modifications thereto may be made without departing from the spirit or scope of the subject invention as defined by the appended claims. In view of the many possible embodiments to which the principles of the disclosed processes may be applied, it should be recognized that the teachings herein are only preferred examples and should not be taken as limiting the scope of the invention.

We claim:

1. A method of reducing or eliminating contamination of particulate silicon from contact with a metal surface during transport of the particulate silicon through a metal conduit, the method comprising:
providing a metal conduit having an inner metal surface that is at least partially coated with a protective layer comprising silicon or a silicon-containing material; and
transporting particulate silicon through the metal conduit.

2. The method of claim 1 wherein the metal surface is completely coated with the protective layer.

3. The method of claim 1 wherein the protective layer comprises a silicon-containing material.

4. The method of claim 3 wherein the silicon-containing material is selected from silica glass, quartz, silicon carbide, or silicon nitride.

5. The method of claim 4 wherein the silicon-containing material is silica glass.

6. The method of claim 5 wherein the silicon-containing material is a silica glass with a silicon content of at least 35 weight percent.

7. The method of claim 6 wherein the coating has a thickness of 0.5 millimeters to 4 millimeters.

8. The method of claim 1 wherein the thickness of the coating is up to 10 millimeters.

9. The method of claim 8 wherein the thickness of the coating is from 0.3 millimeters to 7 millimeters.

10. The method of claim 1 wherein the metal conduit is associated with a fluidized bed reactor, but the metal surface does not define a fluidized bed reactor chamber.

11. The method of claim 10 wherein the metal conduit associated with the fluidized bed reactor is a feed pipeline or discharge pipeline that is in communication with the fluidized bed reactor chamber.

12. A fluidized bed reactor unit for production of polycrystalline silicon, the unit comprising:
a reactor defining a reactor chamber; and
one or more metal pipes that are in communication with and are external to the reactor chamber, wherein the one or more metal pipes have an inner surface at least partially coated with a protective layer comprising a silicon or silicon-containing material.

13. The fluidized bed reactor unit of claim 12 wherein the silicon-containing material is selected from silica glass, quartz, silicon carbide, or silicon nitride.

14. The fluidized bed reactor unit of claim 13 wherein the silicon-containing material is silica glass.

15. The fluidized bed reactor unit of claim 12 wherein the thickness of the coating is up to 10 millimeters.

16. The fluidized bed reactor unit of claim 12 wherein the thickness of the coating is from 0.3 millimeters to 7 millimeters.

17. The fluidized bed reactor unit of claim 12 wherein the silicon-containing material is a silica glass with a silicon content of at least 35 weight percent.

18. The fluidized bed reactor unit of claim 17 wherein the silica glass coating has a thickness of from 0.5 millimeters to 4 millimeters.

19. A process for the production of granulate polycrystalline silicon particles, the process comprising flowing a silicon-containing gas through a fluidized bed reactor containing a seed particle to effect pyrolysis of the silicon-containing gas and deposition of a polycrystalline silicon layer on the seed particle, wherein transportation of the seed particle prior to entry, or granulate polycrystalline silicon after exit from the fluidized bed reactor, is through a metal feed or discharge conduit having a metal inner surface at least partially coated with a protective layer comprising silicon or a silicon-containing material.

20. The process of claim 19 wherein the protective layer prevents contact of a polycrystalline silicon particle with the metal inner surface and thereby reduces or eliminates metal contamination of the polycrystalline silicon particle.
